(19) United States
(12) Patent Application Publication
(10) Pub. No.: US 2007/0216332 A1
(43) Pub. Date: Sep. 20, 2007

(54) Method for Effecting the Movement of a Handling Device and Image Processing Device

(76) Inventors: Georg Lambert, Darmstadt (DE); Enis Ersue, Darmstadt (DE)

Correspondence Address: MICHAEL J. STRIKER, 103 EAST NECK ROAD, HUNTINGTON, NY, 11743, US

(21) Appl. No.: 10/576,129

(22) PCT Filed: Oct. 20, 2004
(86) PCT No.: PCT/EP04/11863

§ 371 Date: Jan. 24, 2007

(30) Foreign Application Priority Data
Oct. 20, 2003 (DE) 103 49 221.6

(51) Int. Cl. B25J 9/16

(52) U.S. Cl. 318/568.1

(57) ABSTRACT

A method for effecting the movement of a handling device with at least one actuating member which can be moved by means of a control device about one or several axes, wherein a) an optically recognizable object and a course of movement is indicated to the control device of the handling device or an image processing device, b) the area of movement and/or working area of the handling device is captured using a camera, c) the image thus captured is evaluated with an image processing device such that the predefined object is recognized and the position and/or state of movement thereof is determined, especially in relation to the handling device, d) the control or image processing device calculates a control command for one or several actuators of the handling device from the position and/or state of movement of the recognized object and the course of movement in relation to the object, e) the control device issues a control command to each actuator to be moved according to said control command, and f) steps b) to e) are carried out once more. The invention also relates to a corresponding image processing device.

The invention relates to a method for arranging the motion of a handling device, in particular having a plurality of movable axes and a control unit, in which the position, time and speed can be specified for each axis. Freedom of motion is advantageously possible about at least three axes, to enable a free disposition in space. If a motion in only one plane is desired, then adjustment capabilities about two axes are sufficient. Depending on the task of the handling device, however, more axes may be provided, which are adjustable by means of corresponding final control elements. The present invention also relates to a corresponding image processor.

The handling device may for instance be a robot; the term robot is understood very generally to mean a device which can execute motion and/or work sequences in an automated way. To that end, the robot has a controller, which outputs adjustment commands to final control elements of the robot so that the final control elements will execute the motions specified to them. To obtain a coordinated motion sequence, it is necessary to specify a defined motion sequence to the handling device.

This is done in known robots or handling devices in that a program runs in the controller, and in this program the motion sequence of the handling device is fixedly programmed in from the very outset. Such handling devices are used for instance in assembling articles in which the handling devices execute identical motion sequences again and again.

A controller for a handling device is also known which is capable of ascertaining a motion sequence on the basis of construction data, such as CAD data, of an object. In this case, the motion of the handling device can be adapted very precisely even to three-dimensional objects, without requiring complicated additional measurement of the objects and inputting of the applicable motion coordinates into the computer program.

In the previously known methods for arranging a motion of a handling device, such as a robot motion, however, there is the disadvantage that the motion sequences and construction data must be defined precisely and stored in memory in advance. To be able to take the motion of the object, for instance on a conveyor belt, into account, the motion of the conveyor belt must also be detected using appropriate motion sensors. This is comparatively complicated and means that the system cannot react flexibly to objects that move themselves or to unexpected situations.

The object of the present invention is therefore to propose a simple way of arranging the motion of a handling device with which the motion sequence of the handling device can be flexibly adapted or automatically changed, that is, without outside intervention, for instance to the motion of an object to be machined.

This object is attained by a method for arranging the motion of a handling device, such as a robot, having at least one final control element movable about one or more axes by means of a controller, in which

a) an optically detectable object and a motion sequence referred to the object are specified to the controller of the handling device or of an image processor;

b) the range of motion and/or working range of the handling device is recorded with a camera;

c) the recorded image is evaluated with an image processor, such that the specified object is detected, and its position and/or motion status, in particular relative to the handling device, is determined;

d) from the position and/or motion status of the detected object and the motion sequence referred to the object, the controller or the image processor calculates a control command for one or more final control elements of the handling device;

e) in accordance with the control command, the controller outputs an adjustment command to each final control element to be moved; and

f) method steps b) through e) are performed again, in particular until the controller receives a stop command.

With the method of the invention, it is therefore possible, for an optically detectable object, to abstractly specify a defined motion sequence, in particular relative to the object, that is then automatically executed by the controller of the handling device, in particular a computer. The optically detectable object is defined by a constellation of optically detectable characteristics that are identifiable by an image processor, such as geometric locations, defined contrasts, and/or other characteristics suitable for detection. As a result, it is possible to close the control circuit between the object, in particular a moving object, and the handling device visually, or in other words by means of a suitable image processor and to follow a moving object with the handling device without the motion sequence having to be known in advance and programmed into the controller of the handling device.

With respect to an optically detectable object of this kind, a defined motion sequence can accordingly be specified in an abstract way. In particular, it is also possible to specify the motion sequence for the handling device relative to an object that itself is in motion, or in other words in particular in the resting system of the object, in order to perform certain tasks on it. The specification of the motion sequence may for instance comprise following a defined object, which is moved in a defined or unpredictable (chaotic) way, by means of the motion of the handling device. It is also possible to detect an edge or seam by specifying a defined contrast value and to guide a robot along this seam or edge. This specification is abstract and need not be supplemented with certain position data of the object, because the position of the object detected in the image recorded is determined relative to the handling device again and again by means of the image processor. Even chaotic motions of an arbitrary object or of unknown objects can thus be detected quickly and flexibly by the controller of the handling device.

From the relative position and/or motion status of the object and the abstractly specified motion command relative to the object, the controller or image processor then calculates a control command for one or more final control elements of the handling device, so that the abstract motion command can in fact be converted into a motion of the handling device by means of suitable adjustment commands to each final control element. The adjustment command leads to a motion of the handling device, as a result of which as a rule either the relative position between the object and the handling device is changed, or the handling device, remaining in a constant relative position, follows the moving object. A new relative position, for instance resulting from a motion of the object, is detected again in accordance with the method steps described above and converted into a new control command.

This way of arranging a motion of a handling device is especially simple for a user, because he need not involve himself in the control program of the handling device or in specifying certain positions to be approached. He can simply use the handling device by specifying an object that is detectable by an image processor and a motion defined abstractly in relation to that object. Thus the robot is capable for instance of automatically following a groove of arbitrary length and arbitrary shape without the requirement that position information on this groove be input or known. This also means great flexibility of the motion sequence, since the robot can on its own even follow new shapes of an object, such as an unintended deviation in the course of the groove or the like, or an unforeseeable independent motion of the object.

A simple application of the method of the invention provides an image processor which in addition to detecting the object also makes the calculation of the relative positions and/or relative motion between the object and the handling device and sends information accordingly, in the form of control commands, on to the controller of the handling device. A conventional controller for handling devices of robots can then be used that need not be adapted for the particular use of the method of the invention. The visual closure of the control circuit is thus accomplished in this case by the image processor itself.

In a preferred embodiment of the present invention, the object itself is moved, and in the ascertainment of the motion status of the object, its location and speed are detected. In particular, it is appropriate to determine the location and speed of the object relative to the handling device, so that this relative motion can be taken into account especially simply in the motion sequence to be executed, which is specified abstractly with respect to the object, for instance in its resting coordinate system.

It is then especially simple to superimpose the motion of the object and the motion of the handling device on one another. This is done with a suitably adapted image processor, preferably in real time. In this method variant, the object motion is accordingly determined and has superimposed on it a motion of the handling device that is either known or is ascertained on the basis of the image processing. It thus also becomes possible, by means of the handling device, to perform work on the moving object, and the motion of the object and/or the motion of the handling device need not be specified in advance. However, it is also possible for the motion sequence of the handling device, for instance relative to the object, to be specified in a program of the controller.

The method can also be used for simple programming of a handling device for arranging a motion of the handling device or robot, especially if the handling device is meant to perform the same motions again and again. In that case, the motion sequence is stored in memory in the form of a train of control commands ascertained during the execution of the motion, especially with appropriate time information. The motion of the handling device can then be effected in the desired order and at the specified time in an especially simple way, on the basis of this stored train of control commands. Storing the control commands in memory, in particular in their chronological order, is accordingly equivalent to setting up a program in a handling device for controlling its motion, but is substantially easier to handle than specifying certain positions or reading in CAD data on the basis of which the motion is then calculated.

According to the invention, it is also possible for a plurality of different motion sequences to be stored in memory, each as a train of control commands, which can then be selected arbitrarily in accordance with a given application.

The selection of a control command or of a train of control commands can also depend on the type, the position and/or motion status of the object detected. This characteristic can be used for instance to ascertain the end of a motion sequence, if a defined constellation of optical characteristics enables the detection of a certain object. Moreover, it is possible as a result, for instance in quality control, to have various motion sequences of a handling device executed automatically as a function of a known error, in order to make error-dependent corrections.

In an especially advantageous feature of the method of the invention the motion of the handling device is monitored on the basis of the images recorded. Particularly if the motion of the handling device is effected on the basis of a train of control commands stored in memory, then as a result it is easy to check whether the conditions for executing the stored train of control commands still exists, such as whether the moving object has been tracked correctly. If that is not the case, the motion sequence can be stopped immediately, for instance to prevent damage to the object.

It is additionally possible according to the invention for tasks to be executed by the handling device to be associated with the motion sequence referred to the object. The type of task may be any activity that can be performed by a handling device-controlled tool. This can be welding work, for instance, sealing a seam, following moving objects, or other tasks.

The tasks may be performed both during the execution of a stored train of control commands in the context of a program-controlled motion of a handling device, or in the motion of a handling device based on the particular currently detected image data.

It is especially advantageous if the image processing and the calculation of a control command are done in real time, so that certain tasks can be performed even when objects are in motion and to make a rapid motion of the handling device possible. In that case, programming of the handling device or storing a train of control commands in memory can often be dispensed with, since the object and/or its motion is detected in real time and thus ascertaining the control commands can also be done in real time. As a result, existing handling devices can be used very flexibly for the most various tasks. Processing the recorded images in real time makes it possible in particular to perform manipulations of moving objects in which both the motion sequence for the manipulations and the motion of the object are executed in real time without prior fixed programming. If the chronological order of manipulations or tasks or work to be performed is already known, then only the motion of the object needs to be detected in real time and have the motion of the handling device superimposed on it.

According to the invention, the image recording can be effected by means of a camera that is stationary and/or moved along with the handling device. The stationary camera unit has the entire range of work and motion of the handling device in view and can therefore detect even unpredicted events especially well, such as chaotic motions of the object to be tracked. The camera unit moved along with the motion of the handling device can conversely be focused on a special work range and compared to the stationary camera unit offers higher optical resolution.

It is therefore especially advantageous to combine one stationary camera and one slaved camera; by means of the image processor, two or more images can be evaluated simultaneously, and in particular even in real time, in order to calculate a control command. Depending on the task, two, three, or more stationary and/or moving cameras may also be provided. Hence the method can be used even if objects unpredictably move or drop out of the field of view of the slaved camera. These objects can then be detected with the stationary camera, and the handling device can be guided in such a way that the handling device tracks this object onward.

By means of the method of the invention for arranging the motion of handling devices, the handling devices thus become much easier to handle and to adapt to certain tasks and activities, since what as a rule is the complicated programming of a handling device program with one or more fixedly specified motion sequences is dispensed with. This enhances the flexibility of use of handling devices, such as robots.

The present invention also relates to an image processor that is especially well suited to performing the method for arranging a motion of a handling device. By means of the image processor, an object, recorded by means of at least one camera, in an image is detected; the position of the object is determined spatially and chronologically and/or its speed is ascertained; a relationship of the position and/or speed of the object to the position and/or speed of a handling device is determined; and in order to make the handling device track the object or to perform certain tasks or manipulations on the object, this relationship is sent onward, for instance in the form of a control command, to the controller of the handling device, in particular for executing a motion sequence referred to the object. This is done as much as possible in real time and makes it possible to control the handling device on the basis of the visual findings of the image processor.

The relationship, required for this purpose, between the object and the handling device can be formed from the difference between the positions and/or speeds of the object and the handling device, particularly in the form of a deviation vector and/or a relative speed vector that is then delivered to the controller. The difference can be delivered directly to the controller, which from that difference generates the corresponding control commands. In an alternative embodiment, the image processor can convert the differences ascertained into control commands that are delivered to the controller, which then generates only the concrete adjustment commands for the final control elements of the handling device.

To record a motion sequence, the camera or cameras can be positioned above the object and tracked along with a motion of the object; the camera motion is recorded, and this recording is converted into motion information for the handling device. In this way, a motion program for a handling device can be generated especially simply, in that an object detected by the image processor in its motion is copied to the various positions. The motion information preferably includes chronological, spatial and/or speed information.

Further characteristics, advantages, and possible applications of the invention will also become apparent from the ensuing description of an example and from the drawing. All the characteristics described and/or shown in the drawings, on their own or in arbitrary combination, form the subject of the invention, regardless of how it is summarized in the claims and regardless of the claims dependencies.

Shown are:

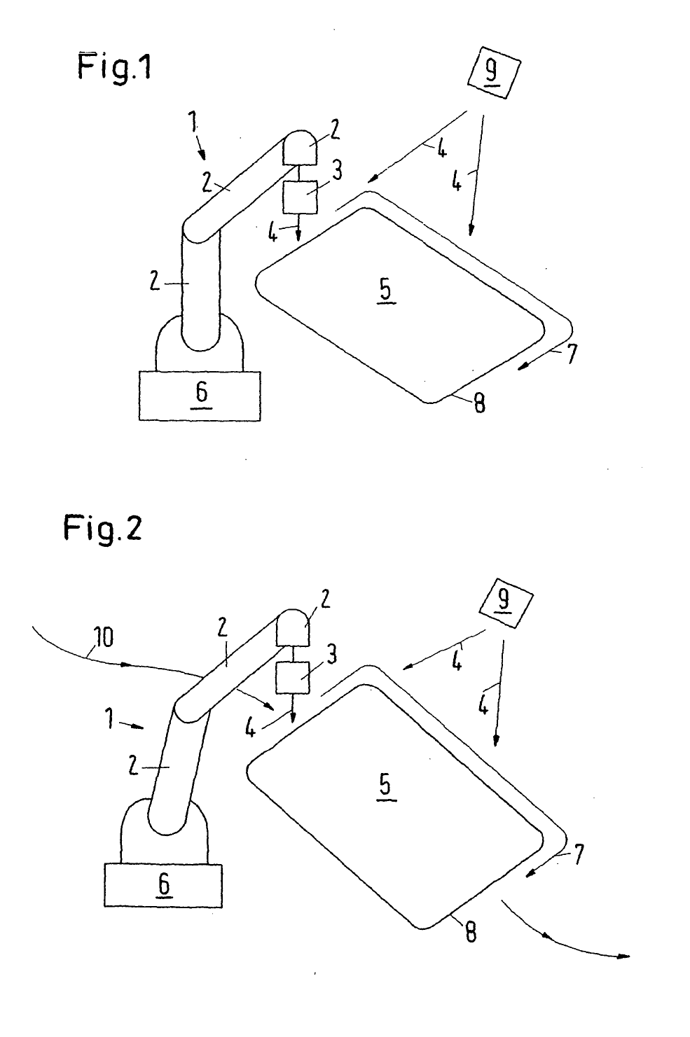

FIG. 1, schematically, the performance of the method of the invention for arranging a motion of a handling device, for an object at rest; and

FIG. 2, schematically, the performance of the method of the invention for arranging a motion of a handling device, for an object in motion.

FIG. 1 shows, as a handling device, a robot 1 with a plurality of final control elements 2, which are movable about various axes and on which a camera 3 is located as a moving sensor. In addition to the camera 3, arbitrary tools, although not shown in FIG. 1, may also be mounted on the robot 1.

The image field 4 of the slaved camera 3 is aimed at the object 5. Detection characteristics for the object 5 and a motion sequence 7 referred to the object 5 are specified in a controller 6, which in the example shown is located directly on the robot 1, but may readily instead be embodied separately from it in an arithmetic unit, and/or in an image processor stored in the same or a separate arithmetic unit.

In the example shown, the robot 1 is intended to follow the edge 8 of the object 5, for instance to check the edge 8 for flaws or, by means of a tool not shown, to perform work on the edge 8. To that end, characteristics for detecting the edge, such as a typical course of contrast in the region of the edge 8, are specified to the image processor of the camera 3. With the camera 3, the range of motion and/or working range of the robot 1 is recorded, and the recorded image is evaluated with the image processor. In the process, the object 5 whose position relative to the robot 1 is determined is identified, and the edge 8 which the handling device is meant to follow on the basis of the abstractly specified motion sequence 7 is also detected.

Based on the known relative position between the camera 3 or robot 1 and the edge 8 of the object 5, the controller 6 or the image processor can calculate a control command for the final control elements 2 of the robot 1 and output it accordingly as an adjustment command to each final control element 2, so that the handling device 1 follows the edge 8 of the object 5, without the motion sequence having to be fixedly programmed in by specifying coordinates in the controller 6. To that end, after each motion of the robot 1, the camera 3 records a new image of the object 5 and repeats the above-described method steps. As a result, an abstract motion sequence 7, referred to the object 5 or to certain visual characteristics of the object 5, can be specified that the robot 1 follows automatically.

It is especially advantageous if the above-described method is implemented by means of an image processor of the camera 3 that transmits the corresponding control commands, for instance in the form of motion coordinates, to the controller 6 of the robot 1, so that now only the respective adjustment commands to the final control elements 2 have to be generated there. In that case, conventional robots 1 or other handling devices with conventional controllers 6 can be used, so that the method of the invention can be implemented simply by means of a suitable image processor.

In addition to the slaved camera 3, a stationary camera 9 may also be provided, which has a larger image field 4 than the slaved camera 3 and serves to detect the object 5 in overview form. Preferably, the camera 9 is also connected to the image processor of the camera 3 and/or to the controller 6 of the robot 1.

Providing a stationary camera 9 is especially appropriate if the object 5, as shown in FIG. 2, is itself in motion. The direction of motion 10 of the object 5 is indicated in FIG. 2 by arrows. The stationary camera 9 serves the purpose of an initial orientation of the object 5 relative to the robot 1. Because of the larger image field 4 of the stationary camera 9 compared to that of the camera 3 mounted on the robot 1, it is simpler to find the object 5 and identify it and to detect unpredicted motion of the object 5, such as slipping on a conveyor belt, quickly and reliably. The precise identification of certain characteristics of the object 5 can then be done with the slaved camera 3.

In this variant method, not only the position of the object 5 but also its motion status relative to the robot 1 are determined. Based on this information, it is possible to guide the handling device 1 along the edge 8 of the object 5 in accordance with the specified motion sequence 7; for the adjustment commands of the final control elements 2, the controller 6 takes the motion of the object 5 into account then from the very onset anyway.

With the method and the image processor it is thus possible in a simple way to arrange the motion of a handling device 1 relative to an object 5 without having to specify precise motion coordinates to the handling device, since the object 5 is detected visually. It is therefore possible, based on an evaluation of the image, to control and adapt the motion of the robot 1 flexibly and quickly.

### List of Reference Numerals

1 Handling device, robot
2 Final control element
3 Camera
4 Image field
5 Object
6 Controller, image processor
7 Motion sequence
8 Edge
9 Camera
10 Direction of motion of the object

1. A method for arranging the motion of a handling device (1), having at least one final control element (2) movable about one or more axes by means of a controller (6), in which
a) an optically detectable object (5) and a motion sequence (7) referred to the object (5) are specified to the controller (6) of the handling device (1) or of an image processor;
b) the range of motion and/or working range of the handling device (1) is recorded with a camera (3, 9);
c) the recorded image is evaluated with an image processor, such that the specified object (5) is detected, and its position and/or motion status, in particular relative to the handling device (1), is determined;
d) from the position and/or motion status of the detected object (5) and the motion sequence (7) referred to the object (5), the controller (6) or the image processor calculates a control command for one or more final control elements (2) of the handling device (1);
e) in accordance with the control command, the controller (6) outputs an adjustment command to each final control element (2) to be moved; and
f) method steps b) through e) are performed again.

2. The method as defined by claim 1, characterized in that the object (5) itself is moved, and its location and speed are detected upon the ascertainment of the motion status of the object (5).

3. The method as defined by claim 1, characterized in that the motion of the object (5) and the motion of the handling device (1) are superimposed.

4. The method as defined by claim 1, characterized in that the motion sequence (7) is stored in memory as a train of control commands ascertained during the execution of the motion of the handling device (1).

5. The method as defined by claim 4, characterized in that the motion of the handling device (1) is effected on the basis of a train of control commands stored in memory.

6. The method as defined by claim 4, characterized in that a plurality of different motion sequences (7) are storable in memory, each as a train of control commands.

7. The method as defined by claim 1, characterized in that the selection of a control command or of a train of control commands depends on the type, the position and/or motion status of the detected object (5).

8. The method as defined by claim 1, characterized in that the motion of the handling device (1) is monitored on the basis of the images recorded.

9. The method as defined by claim 1, characterized in that tasks to be executed by the handling device (1) are associated with the motion sequence (7) referred to the object (5).

10. The method as defined by claim 1, characterized in that the image processing and/or the calculation of a control command are done in real time.

11. The method as defined by claim 1, characterized in that the image recording is effected by means of a camera (9, 3) that is stationary and/or moved along with the handling device.

12. An image processor, in particular for a method for arranging the motion of a handling device (1) as defined by claim 1, in which an object (5), recorded by means of at least one camera (3, 9), in an image is detected; the position of the object (5) is determined spatially and chronologically and/or its speed is ascertained; a relationship of the position and/or speed of the object (5) to the position and/or speed of a handling device (1) is determined; and this relationship is sent onward to the controller (6) of the handling device, in particular for executing a motion sequence (7) referred to the object (5).

13. The image processor as defined by claim 12, characterized in that the relationship is formed, particularly in the form of a deviation vector, from the difference between the positions of the object (5) and the handling device (1).

14. The image processor as defined by claim 12, characterized in that the relationship is formed, particularly in the form of a relative speed vector, from the difference between the speeds of the object (5) and the handling device (1).

15. The image processor as defined by claim 12, characterized in that the camera (3, 9) is positioned above the object (5) and tracks along with a motion of the object (5); the camera motion is recorded , and this recording is converted into motion information for the handling device (1).

16. The image processor as defined by claim 15, characterized in that motion information includes chronological, spatial, and/or speed information.
